(19) United States
(12) Patent Application Publication
(10) Pub. No.: US 2016/0172079 A1
(43) Pub. Date: Jun. 16, 2016

(54) USE OF A CABLE FOR THE TRANSMISSION OF AUDIO SIGNALS

(71) Applicant: Christian ROHRER, Zimmerwald (CH)

(72) Inventor: Christian ROHRER, Zimmerwald (CH)

(21) Appl. No.: 14/903,967

(22) PCT Filed: Jul. 10, 2014
(86) PCT No.: PCT/CH2014/000100

§ 371 Date: Jan. 8, 2016

(30) Foreign Application Priority Data
Jul. 11, 2013 (CH) 1244/13

(51) Int. Cl. H01B 11/12

(52) U.S. Cl. CPC H01B 11/12

(57) ABSTRACT

According to the invention, a cable (10) is used to transmit audio signals, in particular analogue audio signals. Said cable comprises at least two conductors (12.1, 12.2, 12.3, 12.4), a first connection piece on a first end of the cable (10) for connecting the cable (10) to a first device and a second connection piece on a second end of the cable (10) for connecting the cable (10) to a second device. At least one of the conductors (12.2, 12.4) is neither conductively connected to the first connection piece nor conductively connected to the second connection piece.

### TECHNICAL FIELD

The invention relates to a cable and to the use of a cable of this kind for the transmission of audio signals, in particular of analog audio signals, wherein the cable comprises the following: at least two conductors, a first connection piece at a first end of the cable for connecting the cable to a first device, and a second connection piece at a second end of the cable for connecting the cable to a second device. The invention further relates to the use of a cable for the transmission of audio signals, wherein the cable comprises the following: at least one conductor, at least one shielding which shields the at least one conductor, at least one insulated ground connection, a first connection piece at a first end of the cable for connecting the cable to a first device, and a second connection piece at a second end of the cable for connecting the cable to a second device.

### PRIOR ART

In the course of reproducing audio signals, for example in the course of producing sound on private or commercial premises, concert halls etc., analog audio signals, inter alia, are transmitted by means of electrical signals. Low-frequency cables (LF cables), which connect reproduction devices (“audio sources”) and amplifiers and also devices for influencing sound for example, and loudspeaker cables, which connect amplifiers to loudspeakers for example, are used, inter alia, for this purpose. As an alternative to light guides, further cables with electrical conductors are used for transmitting digital audio signals.

The cables which are used for the transmission of audio signals, in particular of analog audio signals, have a particularly important effect on the sound quality. The sound quality is severely adversely affected if cables with an unsuitable construction or with too small a cross section are used.

Shielded cables which comprise a plurality of insulated stranded wires which are surrounded by a shielding are usually used for transmitting analog audio signals. The stranded wires are each conductively connected to contacts of the two connection pieces (for example plugs or sockets). The shielding is conductively connected to the ground contact of at least one of the connection pieces.

It has now been found that complicated measures have to be taken in order to ensure reliable transmission of the audio signals and therefore to allow a good sound to be produced when conventional cables with a construction of this kind are used.

### SUMMARY OF THE INVENTION

The problem of the invention is to propose cables for the transmission of audio signals, in particular of analog audio signals, which cables have a comparatively simple construction and allow good sound quality.

The solution to the problem is defined by the features of Claim 1. According to the invention, at least one of the conductors is neither conductively connected to the first connection piece nor conductively connected to the second connection piece. This means that, even when the cable is fully connected, the said at least one conductor is neither conductively connected to the first device which is connected to the cable nor conductively connected to the second device which is connected to the cable (dummy conductor).

Within the scope of the present embodiments, the term “connection piece” is in each case intended to be understood to mean the entire connector which has a cable at one of its ends. The said connector may be a single- or multi-pole plug or a single- or multi-pole socket, but also a plurality of plugs or sockets or other elements which allow conductive contact to be made with conductors of the cable from the outside. The cable can have connection pieces with different connection arrangements and/or designs at both of its ends. In the simplest case, the connection pieces can also be formed simply by blank wire or stranded wire ends or wire or stranded wire ends which are tin-plated or provided with a different metal coating.

It has been found that the construction according to the invention and the contact-connection according to the invention allow extremely good transmission of audio signals, in particular of analog audio signals, specifically both when LF cables are used and also when loudspeaker cables are used. This is also true in comparison with cables which have a considerably larger conductive cross section than that of the cables which are configured according to the invention. This finding is surprising since the conductive cross section actually provided by the cable remains unused within the scope of the invention.

In contrast to conventional approaches in which attention is paid primarily to the selection of material for the conductors, the invention proposes a novel circuit design.

The cable preferably comprises at least three conductors, wherein at least two of the conductors are neither conductively connected to the first connection piece nor conductively connected to the second connection piece. It has been found that the presence of a plurality of unconnected conductors can lead to a further improvement in the transmission quality.

According to a preferred embodiment, the cable has at least four conductors, wherein at least two of the at least four conductors establish two connections between the first connection piece and the second connection piece (for example “plus” and “minus” in the case of an asymmetrical connection). In addition, at least two further conductors of the at least four conductors are neither conductively connected to the first connection piece nor conductively connected to the second connection piece.

The at least four conductors are now preferably arranged in the cable without crossing over, and the at least two conductors which establish a connection are separated from one another by in each case at least one of the unconnected conductors. “Without crossing over” means that the relative arrangement of the at least four conductors does not change over the entire cable length as viewed in the cross section of the cable. Therefore, screw-like turning of the conductor pack is possible, but it is not possible to change the relative arrangement, that is to say, for example, the order of the conductors in a prespecified direction of rotation. It has been found that the arrangement of the unconnected conductors between the connected conductors is beneficial in respect of the transmission quality.

The at least two conductors are advantageously individually insulated. This ensures that the conductors are insulated from one another throughout the cable. If necessary, it is possible in this case for connections between a plurality of the at least two conductors to be provided in the region of one or both connection pieces or on the device. Instead of separate insulation of the at least two conductors, the conductors can, for example, also be embedded in an insulation medium, or one of the conductors is insulated all the way around, while the other conductor is mounted adjacent to the insulated conductor without insulation.

In a particular embodiment, the cable is a cable for symmetrical signal transmission. Symmetrical transmission of audio signals is performed, for example, via at least triple-core cables with XLR plug connectors. This allows signals to be transmitted without interference, even in the case of relatively long transmission paths. It has now been found that the use of cables according to the invention exhibits advantages in respect of the transmission quality in the case of symmetrical transmission of audio signals, in particular with analog LF cables, too.

A cable which can be used for symmetrical signal transmission according to the invention now comprises at least two signal conductors, at least one ground conductor and at least one conductor which is neither conductively connected to the first connection piece nor conductively connected to the second connection piece. The two signal conductors transport the signal and a reference signal of opposite polarity.

A cable which can be used for symmetrical signal transmission according to the invention preferably comprises at least two signal conductors, at least one ground conductor and at least three conductors which are neither conductively connected to the first connection piece nor conductively connected to the second connection piece. The two signal conductors transport the signal and a reference signal of opposite polarity. The signal conductors, the ground conductor and the three unconnected conductors are advantageously all twisted together, that is to say stranded together.

Furthermore, all of the conductors are advantageously arranged in the cable without crossing over, and the at least two signal conductors and the ground conductor are separated from one another by in each case at least one of the unconnected conductors.

The cable advantageously comprises a core, which is composed of non-conductive material, and conductors which make contact with this core. The core allows a defined arrangement of the conductors which surround it and ensures that conductors which are not adjacent along the circumference and are separated only by the intermediate insulation maintain a certain minimum distance. The core can be produced, for example, from plastic, for example PVC, PU or PE, or else from natural fibers (for example wool or silk).

The core can also be formed by a conductive material, in particular by a dummy conductor, that is to say a conductor which, even when the cable is fully connected, is neither conductively connected to the first device which is connected to the cable nor to the second device which is connected to the cable.

The cable advantageously comprises a shielding. As a result, the influence of external interference signals can be reduced.

In the case of the cable according to the invention, the shielding shields in particular at least two conductors. The said conductors are, for example, at least one dummy conductor and at least one signal conductor.

The shielding is preferably conductively connected at least to the first connection piece or to the second connection piece.

In an advantageous embodiment, the shielding is conductively connected to the corresponding connection piece at the source end, that is to say in the direction of the audio source, but not to the connection piece which is averted from the source.

In other embodiments, the shielding is neither conductively connected to the first connection piece nor to the second connection piece.

At least the first connection piece or the second connection piece preferably comprises a plug which is pressed onto at least one of the conductors. It has been found that better results can be achieved in respect of the transmission quality with a pressed-on plug than with a soldered plug because direct contact is created between conductor and plug. The plug is preferably produced from copper and gold-plated, silver-plated or rhodium-plated. As an alternative, the plug is produced from solid silver or gold.

As an alternative, the conductors can also be connected, for example, by a solder connection to the corresponding contacts of the first or of the second connection piece.

At least one of the conductors is preferably formed by an insulated stranded copper wire. All of the conductors are particularly preferably formed by insulated stranded copper wires. On account of the skin effect, the use of stranded wires for transmitting alternating signals produces a larger effectively conductive cross section than when wires with the same total cross section are used. In addition, flexible cables which have a long service life can be produced by means of stranded wires. The transmission quality can be optimized when high-quality oxygen-free copper (OFC) is used. However, contrary to prevailing opinion, this is not absolutely necessary. Very good transmission values are achieved even when using commercially available copper, as is used, for example, for cables for conducting electricity in the domestic power supply system, within the scope of use according to the invention.

Other materials, such as silver for example, can also be used for the conductors. By way of example, aluminum can also be used as conductor material for the dummy conductors, that is to say the conductors which, even when the cable is fully connected, are neither conductively connected to the first device which is connected to the cable nor to the second device which is connected to the cable.

In a preferred embodiment, a first of the at least two conductors is configured as a wire, and a second of the at least two conductors is configured as a stranded wire. Experiments have shown that the sound quality of the cables according to the invention can be further improved by this combination.

Conductors which are directly provided with an insulation are preferably also used when wires are used. The said conductors can be easily processed (stranded) and ensure that no short circuits occur. As an alternative, the conductors are embedded, for example, in a common insulation medium or physically separated from one another by special spacers.

In a preferred embodiment, the conductor which is neither conductively connected to the first connection piece nor conductively connected to the second connection piece is interrupted at at least one point along its length. It has been found that a further improvement in the transmission quality can be achieved as a result—depending on the application.

A plurality of unconnected conductors which are interrupted at least once can be provided. In this case, the interruption does not have to be made at the same point in the cable. The transmission characteristics of the cable can be influenced by selecting the number of interruptions, the length of the said interruptions and the arrangement of the said interruptions in relation to one another.

In a preferred embodiment of the invention in which the cable serves, in particular, to supply signals to loudspeakers, the cable comprises a first cable component and a second cable component, which two cable components are accommodated by a common sheathing. In this case, the first cable component and the second cable component each comprise at least two conductors, wherein at least one of the two conductors is neither conductively connected to the first connection piece nor conductively connected to the second connection piece. Therefore, each cable component comprises at least one dummy conductor.

In this case, the first cable component and the second cable component each advantageously comprise a dedicated shielding which shields the at least two conductors of the respective cable component. The mutual influencing of the two cable components is minimized as a result.

The first cable component and the second cable component are likewise preferably twisted together. This results, in particular, in improved mechanical properties of the cable which is constructed from two cable components.

In particular, the two cable components are connected to the first and to the second connection piece in such a way that a first polarity (for example the actual audio signal) is carried exclusively by the first cable component and a second polarity (for example the ground) is carried exclusively by the second cable component. Mutual influencing of the signals of the two polarities is minimized as a result.

A cable which comprises the following:
a) at least one conductor;
b) at least one shielding which shields the at least one conductor;
c) at least one insulated ground connection;
d) a first connection piece at a first end of the cable for connecting the cable to a first device;
e) a second connection piece at a second end of the cable for connecting the cable to a second device;

wherein
f) the shielding is conductively connected at most to one of the two connection pieces; and
g) the ground connection is routed outside the shielding

can be used within the scope of the use according to the invention, but also independently thereof.

Therefore, the ground connection is not made by means of the shielding of the shielded cables, but rather by means of the ground connection which runs outside the shielding. This configuration is particularly suitable for LF device cables. When a signal source is connected to an amplifier, the shielding is preferably connected to the signal source, but not to the amplifier. It has been found that the transmission quality for audio signals can also be considerably increased by these measures.

In contrast to conventional approaches, a novel or particular material is not selected for the conductors in this case either, but rather a different circuit design is used.

In a preferred embodiment, the ground connection is routed in an insulation of the cable. Although the cable appears to be a unit, from a functional point of view it is actually two cables, specifically the shielded signal cable and the ground cable which runs parallel to the said shielded signal cable and runs outside the shielding of the signal cable. The combined insulation has the additional task of mounting the two cables at a specific distance and of simplifying handling.

As an alternative to this, the ground connection is a completely separate cable which is routed into the corresponding connection pieces only at its ends together with the signal cable (which comprises the at least one conductor).

An adapter cable can be used in connection with the separate ground connection. The said adapter cable comprises
a first intermediate piece which can be connected to a first device and to which a first connection piece of a cable can be connected;
a second intermediate piece which can be connected to a second device and to which a second connection piece of the cable can be connected;
an insulated ground connection which connects a ground contact of the first intermediate piece to a ground contact of the second intermediate piece;

wherein at least one of the intermediate pieces is designed in such a way that it does not establish a ground connection between the corresponding device and the cable even when the cable is plugged into the said intermediate piece and when the intermediate piece is plugged in.

The ground connection is preferably interrupted in one of the intermediate pieces, but in effect in the other intermediate piece. The intermediate piece with the interrupted ground connection is then advantageously plugged into the device which is remote from the signal source. A conventional (and possibly already present), in particular shielded, cable which further serves as a signal conductor can be used together with the adapter cable.

Further advantageous embodiments and combinations of features of the invention can be gathered from the following detailed description and all of the patent claims.

### BRIEF DESCRIPTION OF THE DRAWINGS

In the drawings which are used to explain the exemplary embodiment:

FIG. 1 shows a first embodiment of a cable which is suitable for transmitting audio signals according to the invention;

FIG. 2 shows a second embodiment of a cable which is suitable for transmitting audio signals according to the invention;

FIG. 3 shows a third embodiment of a cable combination which is suitable for transmitting audio signals according to the invention;

FIG. 4 shows a fourth embodiment of a cable which is suitable for transmitting audio signals according to the invention;

FIG. 5 shows a fifth embodiment of a cable which is suitable for transmitting audio signals according to the invention; and

FIG. 6 shows a sixth embodiment of a cable which is suitable for transmitting audio signals according to the invention.

In principle, identical parts are provided with identical reference symbols throughout the figures.

### WAYS OF IMPLEMENTING THE INVENTION

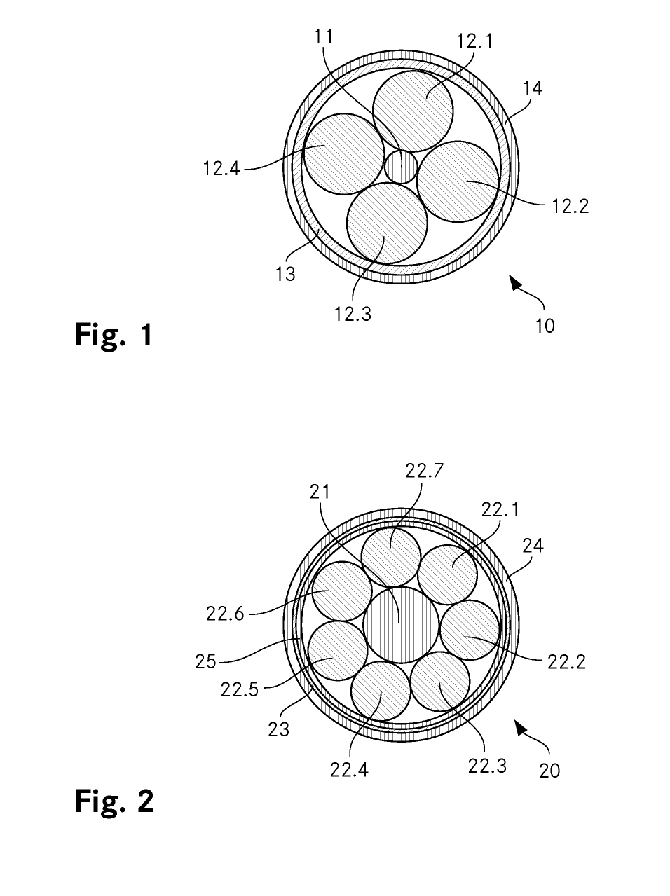

FIG. 1 shows a cross section through a first embodiment of a cable which is suitable for transmitting audio signals according to the invention. The cable 10 is particularly suitable for asymmetrically transmitting audio signals. The said cable comprises a core 11, which is composed of an insulating plastic material, and four insulated stranded copper wires 12.1, 12.2, 12.3, 12.4 which surround the core. The cross section of the said stranded copper wire is 6 mm² in each case. The stranded wires are stranded with the core, that is to say they run along a helical line around the core without crossing over. The stranded wires and the core are jointly surrounded by a shielding 13 which is designed as a braid which is composed of a suitable metal, for example of tin-plated copper wire. As an alternative or in addition, the shielding 13 can also comprise a foil. The entire cable 10 is surrounded on the outside by a suitable insulation 14 which is composed of, for example, plastic such as PVC, PU or PE and forms the cable jacket.

One of two stranded copper wires 12.1, 12.3 which are situated diagonally opposite one another is connected to the positive poles, and the other of the said stranded copper wires is connected to the negative poles of the connection plugs (for example cinch plugs) or to separate plugs (for example “banana plugs”) for the positive and the negative pole. The further stranded copper wires 12.2, 12.4 which are likewise situated opposite one another and which are arranged between the connected conductors are not connected to plugs, but rather end, in particular, at the point at which the insulation 14 also ends. The shielding 13 is connected to the ground pole of the respective plug at one cable end or at both cable ends. The plugs have contact and connection parts which are composed of gold-plated copper (or copper which is finished in some other way) and are pressed (forged) onto the stranded copper wires 12.1, 12.3 which are stripped of insulation.

FIG. 2 shows a cross section through a second embodiment of a cable which is suitable for transmitting audio signals according to the invention. The cable 20 is particularly suitable for symmetrically transmitting audio signals. The said cable comprises a core 21, which is composed of an insulating plastic material, and seven insulated stranded copper wires 22.1 . . . 22.7 which surround the core and have a cross section of 1.5 mm² in each case. The stranded wires are stranded with the core, that is to say they run along a helical line around the core without crossing over. The stranded wires and the core are jointly surrounded by a sheath 25, and the said sheath is in turn surrounded by a shielding 23 which is designed as a braid which is composed of tin-plated copper wire. As an alternative or in addition, the shielding 23 can also comprise a foil. The entire cable 20 is surrounded on the outside by an insulation 24 which is composed of, for example, plastic such as PVC, PU or PE and forms the cable jacket.

Three stranded copper wires 22.1, 22.3 and 22.5, none of which are adjacent, are each connected either to the positive poles, to the negative poles or to the ground poles of the connection plugs (for example XLR plugs) or to separate plugs (for example “banana plugs”) for the three poles. The further stranded copper wires 22.2, 22.4, 22.6, 22.7 which are arranged between the connected conductors are not connected to plugs, but rather end, in particular, at the point at which the insulation 24 also ends. The shielding 23 is connected to the ground pole of the respective plug at one cable end or at both cable ends. The plugs have contact and connection parts which are composed of gold-plated copper (or copper which is finished in some other way) and are pressed (forged) onto the stranded copper wires 22.1, 22.3, 22.5 which are stripped of insulation.

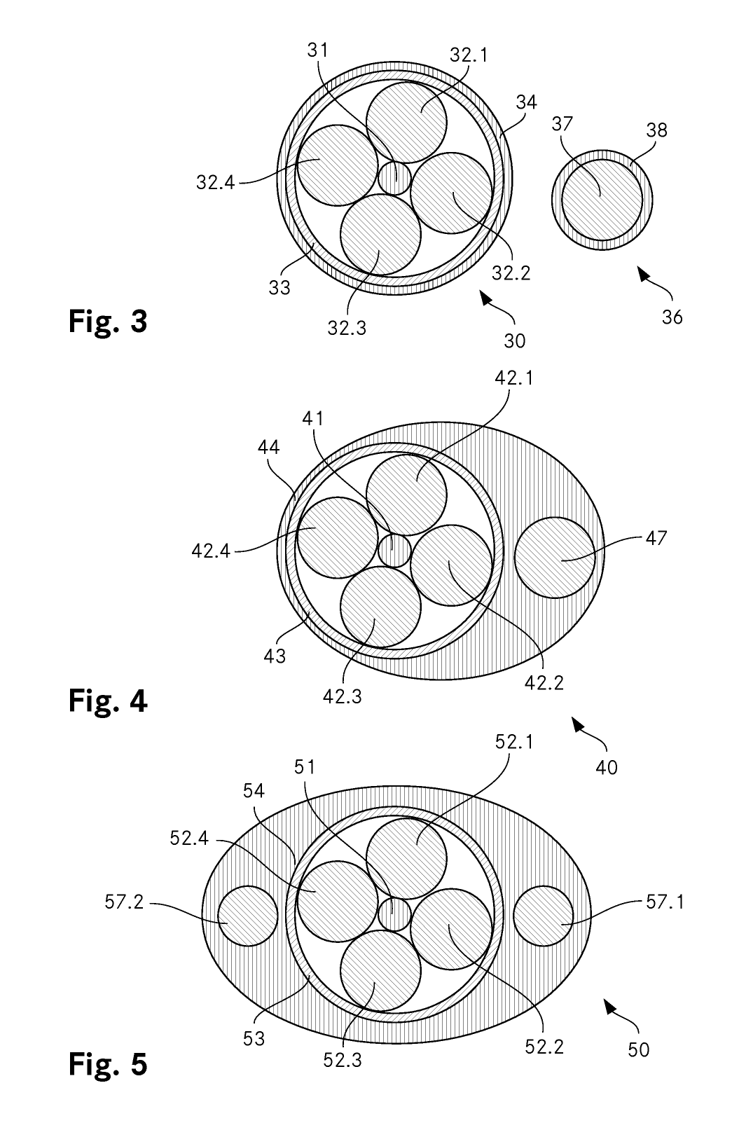

FIG. 3 shows a cross section through a third embodiment of a cable combination which is suitable for transmitting audio signals according to the invention. The combination is particularly suitable for asymmetrically transmitting audio signals. The said combination comprises a signal cable 30 with a core 31, which is composed of an insulating plastic material, and four insulated stranded copper wires 32.1, 32.2, 32.3, 32.4 which surround the core. The stranded wires are stranded with the core, that is to say they run along a helical line around the core without crossing over. The stranded wires and the core are jointly surrounded by a shielding 33 which is designed as a braid which is composed of tin-plated copper wire. As an alternative or in addition, the shielding 33 can also comprise a foil. The entire signal cable 30 is surrounded on the outside by an insulation 34 which is composed of plastic, for example PVC, PU or PE, and forms the cable jacket.

Two stranded copper wires 32.1, 32.3 which are situated diagonally opposite one another are jointly connected to the positive pole of the connection plugs (for example cinch plugs) or to a separate plug (for example “banana plug”) for the positive pole. The further stranded copper wires 32.2, 32.4 which are likewise situated opposite one another and are arranged between the connected conductors are not connected to plugs, but rather end, in particular, at the point at which the insulation 34 also ends. The shielding 33 is connected to the ground pole of the respective plug at one cable end but not at the other cable end. That cable end with the shielding connected is advantageously plugged in at the signal-source end. The plugs have contact and connection parts which are composed of gold-plated copper and are pressed (forged) onto the stranded copper wires 32.1, 32.3 which are stripped of insulation.

The cable combination additionally has a ground cable 36 which is constructed from a stranded copper wire 37 and an insulation 38 which surrounds the said stranded copper wire. The cross section of the stranded copper wire 37 corresponds approximately to the sum of the cross sections of the stranded copper wires 32.1, 32.3. The ground cable 36 is routed separately from the signal cable 30 and is connected to the ground pole of the respective plug or to a separate ground plug at both ends.

FIG. 4 shows a cross section through a fourth embodiment of a cable which is suitable for transmitting audio signals according to the invention. The cable 40 is particularly suitable for asymmetrically transmitting audio signals. The said cable comprises a core 41, which is composed of an insulating plastic material, and four insulated stranded copper wires 42.1, 42.2, 42.3, 42.4 which surround the core. The stranded wires are stranded with the core, that is to say they run along a helical line around the core without crossing over. The stranded wires and the core are jointly surrounded by a shielding 43 which is designed as a braid which is composed of tin-plated copper wire. As an alternative or in addition, the shielding 43 can also comprise a foil. The shielded stranded wires 42.1 . . . 4 are accommodated in an insulation 44 which is composed of, for example, plastic such as PVC, PU or PE and forms the cable jacket. A ground conductor 47 which is arranged outside the shielding 43 of the stranded copper wires 42.1 . . . 4 is further accommodated in the insulation 44.

Two stranded copper wires 42.1, 42.3 which are situated diagonally opposite one another are jointly connected to the positive pole of the connection plugs (for example cinch plugs) or to a separate plug (for example “banana plug”) for the positive pole. The further stranded copper wires 42.2, 42.4 which are likewise situated opposite one another and are arranged between the connected conductors are not connected to plugs, but rather end, in particular, at the point at which the insulation 44 also ends. The shielding 43 is connected to the ground pole of the respective plug at one cable end but not at the other cable end. That cable end with the shielding connected is advantageously plugged in at the signal-source end. The plugs have contact and connection parts which are composed of gold-plated copper (or copper which is finished in some other way) and are pressed (forged) onto the stranded copper wires 42.1, 42.3 which are stripped of insulation.

The ground conductor 47 is connected to the ground pole of the respective plug or to a separate ground plug at both ends.

FIG. 5 shows a cross section through a fifth embodiment of a cable which is suitable for transmitting audio signals according to the invention. The said embodiment corresponds to the fourth embodiment in many respects. The said cable 50 is also particularly suitable for asymmetrically transmitting audio signals. The said cable comprises a core 51, which is composed of an insulating plastic material, and four insulated stranded copper wires 52.1, 52.2, 52.3, 52.4 which surround the core. The stranded wires are stranded with the core, that is to say they run along a helical line around the core without crossing over. The stranded wires and the core are jointly surrounded by a shielding 53 which is designed as a braid which is composed of tin-plated copper wire. As an alternative or in addition, the shielding 53 can also comprise a foil. The shielded stranded wires 52.1 . . . 4 are accommodated in an insulation 54 which is composed of, for example, plastic such as PVC, PU or PE and forms the cable jacket. Two ground conductors 57.1, 57.2 which are arranged opposite one another outside the shielding 53 of the stranded copper wires 52.1 . . . 4 are further accommodated in the insulation 54.

Two stranded copper wires 52.1, 52.3 which are situated diagonally opposite one another are jointly connected to the positive pole of the connection plugs (for example cinch plugs) or to a separate plug (for example “banana plug”) for the positive pole. The further stranded copper wires 52.2, 52.4 which are likewise situated opposite one another and are arranged between the connected conductors are not connected to plugs, but rather end, in particular, at the point at which the insulation 54 also ends. The shielding 53 is connected to the ground pole of the respective plug at one cable end but not at the other cable end. That cable end with the shielding connected is advantageously plugged in at the signal-source end. The plugs have contact and connection parts which are composed of gold-plated copper (or copper which is finished in some other way) and are pressed (forged) onto the stranded copper wires 52.1, 52.3 which are stripped of insulation.

The ground conductors 57.1, 57.2 are connected to the ground pole of the respective plug or to a separate ground plug at both ends.

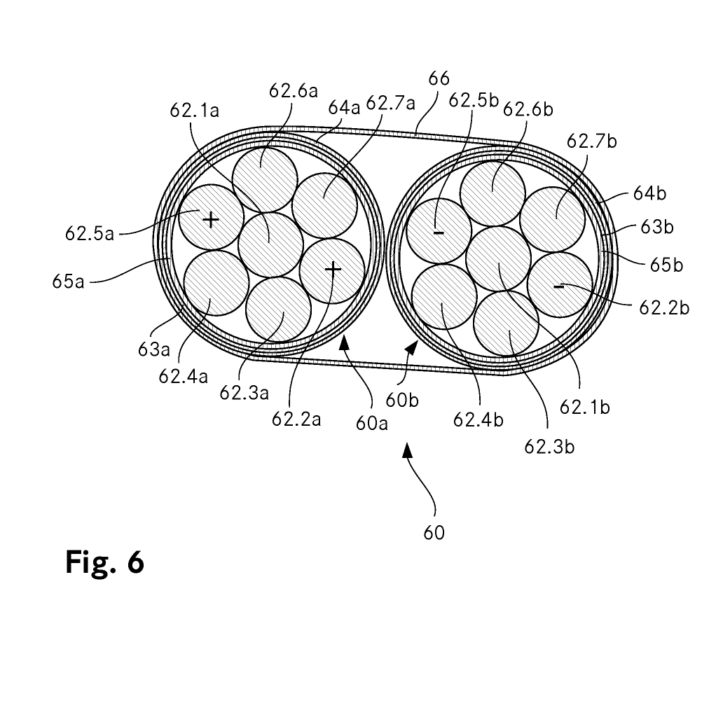

FIG. 6 shows a sixth embodiment of a cable which is suitable for transmitting audio signals according to the invention. The cable 60 is particularly suitable for driving loudspeakers and connects, for example, an (output) amplifier to a loudspeaker. The said cable comprises two cable components 60a, 60b which are routed in parallel. Each of the cable components contains seven stranded copper wires 62.1a . . . 62.7a; 62.1b . . . 62.7b with a cross section of 4.0 mm² in each case (other cross sections, in particular in the range of from 0.5-6.0 mm², are likewise feasible). The stranded wires are surrounded by a sheath 65, and the said sheath is in turn surrounded by a shielding 63 which is designed as a braid which is composed of tin-plated copper wire. As an alternative or in addition, the shielding 63 can also comprise a foil. Each cable component 60a, 60b is surrounded on the outside by an insulation 64a, 64b which is composed of, for example, plastic such as PVC, PU or PE and forms the cable component jacket.

The two cable components 60a, 60b are twisted together and are jointly surrounded by a braid 66.

Two stranded copper wires 62.2a, 62.5a; 62.2b, 62.5b of each cable component 60a, 60b, which stranded copper wires are situated diametrically opposite one another, are jointly connected to the positive pole (cable component 60a) or to the negative pole (cable component 60b) of a suitable plug (for example “banana plug”). The further stranded copper wires 62.1a, 62.3a, 62.4a, 62.6a, 62.7a; 62.1b, 62.3b, 62.4b, 62.6b, 62.7b which are arranged between the connected conductors are not connected to plugs, but rather end, in particular, at the point at which the insulation 64a, 64b also ends. The shielding 63 is likewise not connected to the plugs. The plugs have contact and connection parts which are composed of gold-plated copper (or copper which is finished in some other way) and are pressed (forged) onto the stranded copper wires 62.2a, 62.5a; 62.2b, 62.5b which are stripped of insulation.

The invention is not restricted to the illustrated exemplary embodiments. For example, a ground conductor which is electrically and/or physically separated from the signal cable can also be used for symmetrical signal transmission. The number of conductors and the cross sections of the said conductors and also the materials used can also be readily matched to the application, specifically to the currents which are to be transmitted and the line lengths, within the scope of the invention. The fitting and contact-connection of the cables to the connection pieces or plugs can likewise be performed in a different way, for example by being pressed on or forged, soldered etc.

In summary, it can be stated that the invention provides cables for the transmission of audio signals, in particular of analog audio signals, which cables have a comparatively simple construction and allow good sound quality.

1-32. (canceled)

33. A method for the transmission of audio signals, in particular of analog audio signals, using a cable wherein the cable comprises the following:
a) at least two conductors;
b) a first connection piece at a first end of the cable for connecting the cable to a first device;
c) a second connection piece at a second end of the cable for connecting the cable to a second device;
d) a shielding which shields the at least two conductors; wherein
e) at least one of the conductors is neither conductively connected to the first connection piece nor conductively connected to the second connection piece.

34. Method according to claim 33, wherein the cable comprises at least three conductors, wherein at least two of the conductors are neither conductively connected to the first connection piece nor conductively connected to the second connection piece.

35. Method according to claim 34, wherein the cable has at least four conductors, wherein at least two of the at least four conductors establish two connections between the first connection piece and the second connection piece, and at least two further conductors of the at least four conductors are neither conductively connected to the first connection piece nor conductively connected to the second connection piece.

36. Method according to claim 35, wherein the at least four conductors are arranged in the cable without crossing over, and in that the at least two conductors which establish a connection are separated from one another by in each case at least one of the unconnected conductors.

37. Method according to claim 33, wherein the at least two conductors are individually insulated.

38. Method according to claim 33, wherein a first of the at least two conductors is configured as a wire, and a second of the at least two conductors is configured as a stranded wire.

39. Method according to claim 33, wherein the cable comprises a first cable component and a second cable component, which two cable components are accommodated by a common sheathing, wherein the first cable component and the second cable component each comprise at least two conductors, wherein at least one of the two conductors is neither conductively connected to the first connection piece nor conductively connected to the second connection piece.

40. Method according to claim 39, wherein the first cable component and the second cable component each comprise a dedicated shielding which shields the at least two conductors.

41. Method according to claim 39, wherein the first cable component and the second cable component are twisted together.

42. Method according to claim 39, wherein the two cable components are connected to the first and to the second connection piece in such a way that a first polarity is carried exclusively by the first cable component and a second polarity is carried exclusively by the second cable component.

43. Method according to claim 33, wherein the audio signal is transmitted in a symmetrical manner.

44. Method according to claim 43, wherein the cable comprises at least two signal conductors, at least one ground conductor and at least three conductors which are neither conductively connected to the first connection piece nor conductively connected to the second connection piece.

45. Method according to claim 44, wherein all of the conductors are arranged in the cable without crossing over, and in that the at least two signal conductors and the ground conductor are separated from one another by in each case at least one of the unconnected conductors.

46. Method according to claim 33, wherein the cable comprises a core, which is composed of non-conductive material, and conductors which make contact with this core.

47. Method according to claim 33, wherein the shielding is conductively connected at least to the first connection piece or to the second connection piece.

48. Method according to claim 33, wherein at least the first connection piece or the second connection piece comprises a plug which is pressed onto at least one of the conductors.

49. Method according to claim 33, wherein at least one of the conductors is formed by an insulated stranded copper wire.

50. Method according to claim 33, wherein a first of the at least two conductors is configured as a wire, and a second of the at least two conductors is configured as a stranded wire.

51. Method according to claim 33, wherein the conductor which is neither conductively connected to the first connection piece nor conductively connected to the second connection piece is interrupted at at least one point along its length.

52. Method according to claim 34, wherein the at least two unconnected conductors are interrupted at different points along their length.

53. Method according to claim 33, wherein the cable comprises
at least one insulated ground connection;
a first connection piece at a first end of the cable for connecting the cable to a first device;
a second connection piece at a second end of the cable for connecting the cable to a second device; wherein
the shielding is conductively connected at most to one of the two connection pieces; and
the ground connection is routed outside the shielding.

54. Method according to claim 53, wherein the ground connection is routed in an insulation of the cable.

55. Cable for the transmission of audio signals, in particular of analog audio signals, wherein the cable comprises the following:
a) at least two conductors;
b) a first connection piece at a first end of the cable for connecting the cable to a first device;
c) a second connection piece at a second end of the cable for connecting the cable to a second device;
d) a shielding which shields the at least two conductors; wherein
e) at least one of the conductors is neither conductively connected to the first connection piece nor conductively connected to the second connection piece; and
f) a first of the at least two conductors is configured as a wire, and a second of the at least two conductors is configured as a stranded wire.

56. Cable for the transmission of audio signals, in particular of analog audio signals, wherein the cable comprises the following:
a) at least two conductors;
b) a first connection piece at a first end of the cable for connecting the cable to a first device;
c) a second connection piece at a second end of the cable for connecting the cable to a second device;
d) a shielding which shields the at least two conductors; wherein
e) at least one of the conductors is neither conductively connected to the first connection piece nor conductively connected to the second connection piece; and
f) the cable comprises a first cable component and a second cable component, which two cable components are accommodated by a common sheathing, wherein the first cable component and the second cable component each comprise at least two conductors, wherein at least one of the two conductors is neither conductively connected to the first connection piece nor conductively connected to the second connection piece.
